(19) United States
(12) Patent Application Publication
(10) Pub. No.: US 2026/0363495 A1
(43) Pub. Date: Nov. 19, 2026

(54) Sanitary Material Dispensers

(71) Applicant: CFS Brands, LLC., Oklahoma City, OK (US)

(72) Inventors: William Hunter Pitts, Edmond, OK (US); Jacek Pieczaba, Arlington Heights, IL (US)

(21) Appl. No.: 19/677,740

(22) Filed: May 14, 2026

Related U.S. Application Data
(60) Provisional application No. 63/805,515, filed on May 14, 2025.
(60) Provisional application No. 63/961,745, filed on Jan. 16, 2026.

(51) Int. Cl. A47K 10/36; A47K 5/12; G01F 23/28; A47K 10/38

(52) U.S. Cl. CPC A47K 10/36; A47K 5/12; G01F 23/28; A47K 2010/3668; A47K 2010/389

(57) ABSTRACT

A point of use dispenser assembly and method of forming dispenser assemblies that incrementally dispense sanitation materials directly to a user. The dispenser assembly includes a housing that generally supports a bulk supply of a discrete sanitation material. A sensor is disposed in the housing and is oriented to be in a line-of-sight communication with the bulk supply of sanitation material. The sensor is configured to detect a single level of the bulk supply and provide an indication external to the housing as to a relative level of bulk material available for dispensing.

### CROSS REFERENCE TO RELATED PATENTS

This application claims priority to U.S. Provisional Application Ser. No. 63/805,515 filed on May 14, 2025 and U.S. Provisional Application Ser. No. 63/961,745 filed on Jan. 16, 2026, both titled SANITARY MATERIAL DISPENSERS, and the disclosures of which are both incorporated herein.

### BACKGROUND OF THE INVENTION

The present invention relates generally to point of use dispensers and, more specifically, dispensers that are constructed to incrementally dispense sanitation materials; such as liquid soaps or the like, webbed paper materials such as hand towels or the like, and other paper materials such as tissue or toilet paper or the like, from bulk sources, supplies, or rolls that are contained in a housing and dispensed directly to the user or consumer of the sanitation materials. More particularly, the present invention relates to soap, tissue or toilet paper, and towel dispensers that are constructed to passively monitor a volume of material available for dispensing and which provide an indication of dispenser service being necessary or desired. Another aspect of the present invention relates to methods of providing and dispensers having an economical construction and are constructed to accommodate wireless communication and interaction with the underlying dispensers by the user or owner when desired or necessary.

Dispensers for rolls of flexible sheet material, such as toilet and paper toweling, have been employed for many years. Such dispensers are widely used in public lavatories to dispense the toweling materials. Typically, a roll of sheet material is rotatably supported inside a dispenser cabinet. In manually operated devices, a user interacts directly with the sheet material and/or manually actuates a lever or handle that drives a feed mechanism configured to dispense a discrete dose of the sheet material beyond the confines of the housing. While toilet tissue can commonly be manually extracted from the housing by the user, when configured to dispense hand towel materials, the feed mechanism typically includes a drive roller and an idle roller. The lever interacts with the drive roller so that actuation of the lever rotates the drive roller. Rotation of the drive roller acts to unwind material from the bulk material roll. One such dispenser is described in U.S. Patent No. 7,168,653, the disclosure of which is incorporated herein.

U.S. Patent No. 7,168,653 describes a web material dispenser having a front-mounted hand crank or handle that, when pushed/pulled downward, causes sheet material to be advanced from the roll and thereby dispensed from the dispenser. U.S. Patent Application Publication No. 2012/0181371, the disclosure of which is also incorporated herein, describes another roll dispenser having a hand crank or handle that is side-mounted relative to the dispenser but, when pushed/pulled downward, also causes sheet material to be advanced from the roll. Such dispensers require direct interaction with the hand of the user or those nearby, such as a parent, to effectuate operation of the advancement and feed mechanisms associated with dispensing the sheet material from the dispenser.

The dispensers described in the above-referenced patent documents, as well as other manually activated dispensers, have a lever mounted to or extending from areas proximate the front of the respective dispenser. The lever interfaces with a feed mechanism such as a drive roller such that, operation of the lever – whether being pushed or pulled in an upward, downward, or forward direction, actuates the drive roller which in turn advances the roll of sheet material. Dispensers of this nature are generally referred to as manual dispensers and require a user to place a hand (or portion thereof) on the lever to advance sheet material from the roll.

For applications wherein users are reluctant to have their hands contact such dispensers in an effort to avoid contact with possible contagions associated with prior users of the respective dispensers, other towel dispenser assemblies are implemented in so-called “contactless” dispensers. Such dispensers; whether constructed to dispense liquid soaps, toilet tissue, or hand towels; commonly use one or more proximity sensors that detect the presence of a hand of a user relative to the dispenser and include a motorized feed assembly that advances or dispenses the sheet material. Contactless dispensers are not without their respective drawbacks. The electronic detection and motorized feed mechanisms can be expensive to acquire and implement and can include sensitive sensors intended to prevent unintended activation and/or operation of the dispensing system. As such, many currently available electronic contactless or “hands-free” dispensers may not provide the desired operability and/or be an economically viable solution in some situations and/or desired implementations of such devices.

One shortfall of many such dispenser assemblies, regardless of the nature of the consumable material being dispensed, is the ability of the service personnel and/or those associated with maintaining operability of a plurality of dispensers associated with the use environment to maintain operability of the discrete dispensers and/or to suitably effectuate the dispenser service activities. Various approaches have been undertaken to improve dispenser service functions to maintain the operability of dispensers associated with the discrete environment. In a most rudimentary methodology, service personnel are required to physically inspect each dispenser assembly associated with a discrete environment and effectuate refilling and/or reloading operations when necessary. Such approaches can be both time consuming and labor intensive and exacerbated by the number of discrete dispensers associated with discrete environments and the number of discrete environments associated with discrete facilities.

To mitigate time and labor associated with physical interaction by service personnel with each discrete dispenser assembly to assess the readiness of the discrete dispenser assemblies for dispensing operations, other methodologies provide discrete dispenser assemblies that include wired and/or wireless communication functionality. When constructed to include such functionality, each dispenser is constructed to initiate or effectuate a “call for service” when the bulk material associated with a discrete dispenser assembly nears or has achieved a depleted condition. Such approaches are, however, more expensive to manufacture, maintain, and increase facility costs associated with deployment and/or integration of such systems due to the infrastructure required to maintain the communication protocols with the discrete dispensers and/or acquisition and maintenance of the various interfacing devices associated with achieving the desired service personnel interaction with dispenser systems configured in such a manner. The drawbacks discussed above are not limited to towel or tissue dispensing devices. Other dispensing devices, such as hand soap dispensers or the like are also common to lavatory, kitchen, and many other cleaning environments. User and service personnel interaction with such devices, and/or the integration of such dispensers into the dispenser environment service activities, can suffer from drawbacks similar to those disclosed above.

Accordingly, there is a need for a dispenser assembly that is constructed to incrementally dispense a sanitation material directly to a user and which has a lower cost construction than other dispenser assemblies that are similarly constructed to alert service personnel to the need for service and/or refilling of discrete dispenser assemblies. There is a further need for a dispenser assembly that is constructed to alert service personnel as to a need for service without requiring physical interaction with the discrete dispenser assembly. There is still a further need for dispenser assemblies that are constructed to allow authorized users such as service personnel or the like to assess and/or manipulate and/or interact with discrete dispenser assemblies while negligibly affecting the cost to produce and maintain the discrete dispenser assemblies.

### SUMMARY OF THE INVENTION

The present invention discloses point of use sanitation material dispenser assemblies and methods of forming dispenser assemblies that incrementally dispense sanitation materials directly to a user and resolve one or more of the shortcomings disclosed above. One aspect of the present application discloses a point of use dispenser assembly that includes a housing that generally supports a bulk supply of a discrete sanitation material. A sensor is disposed in the housing and is oriented to be in a line of sight communication with the bulk supply of sanitation material. The sensor is configured to detect a single level of the bulk supply and provide an indication external to the housing as to a relative level of bulk material available for dispensing. Preferably, the dispenser assembly is configured to provide an indication of the available bulk material being above the single level, another indication of the available bulk material being proximate the single level, and yet another indication of the available bulk material being less than single level.

Another aspect of the invention that is useable and/or combinable with one or more of the above features, aspects, or objects discloses a sanitation material dispenser assembly that includes a housing defined by a cover that movably cooperates with a base. A cavity is defined by the housing and is shaped to support a supply of a consumable material. A dispense assembly is disposed in the housing and is configured to incrementally dispense the consumable material to an end user of the consumable material such that the consumable material can be incrementally depleted from a full condition to a depleted condition. A controller is supported by the housing and a sensor is connected to the controller. The sensor is configured to detect a single level of the consumable material wherein the single level is between the full condition and the depleted condition of the consumable material. The dispenser assembly includes an output that provides an indication external to the housing of an available level of the consumable material relative to the single level.

A further aspect of the invention that is useable and/or combinable with one or more of the above features, aspects, or objects discloses a material dispenser assembly that includes a housing constructed to support a bulk supply of a material to be dispensed. A dispense assembly is disposed in the housing and configured to incrementally dispense the material from the bulk supply between a full condition and a depleted condition during use of the material dispenser assembly. A controller is disposed in the housing and a sensor is operatively connected to the controller and configured to touchlessly detect a single level that is between the full condition and the depleted condition of the material available in the housing.

Yet another aspect of the present invention that is useable and/or combinable with one or more of the above features, aspects, or objects discloses a method of forming a dispenser assembly. The method includes providing a housing that is shaped to generally enclose a volume of a dispensable material. A dispense assembly is provided that incrementally dispenses the dispensable material from the housing to a user of the dispensable material in response to a request from a user for a discrete dose of the dispensable material. A sensor is provided that detects a single level that is between a full level condition and a depleted level condition associated with the capacity of the housing of the dispensable material, that is available for dispensing. The sensor is connected to an indicator that is inspectable from outside the housing and whose operation is indicative of a volume of the dispensable material that is available for dispensing being proximate the single level. In a preferred aspect, the dispenser assembly is constructed to provide multiple indicators associated with discrete levels of dispensable material being available and determined from the sensed single level.

A further aspect of the present invention discloses a sanitation material dispenser assembly having a housing that is constructed to enclose a bulk volume of a dispensable material. A dispense system is constructed to incrementally dispense directly to a user a discrete dose of the bulk material directly to the user in response to a dispense instruction. A control arrangement is configured to receive the dispense instruction and actuate the dispense system upon receipt of the dispense instruction to effectuate a dispense event. The control arrangement is further configured to wirelessly communicate with a personal device positioned within line-of-sight proximity to the dispenser assembly and allows wireless communication between the personal device and the control arrangement of the dispenser assembly.

Another aspect of the invention discloses a material dispenser assembly having a housing that is constructed to support a bulk supply of a material to be dispensed and a dispense assembly incrementally dispenses the material from the bulk supply between a full condition and a depleted condition during use of the material dispenser assembly. A passive communication device is associated with the material dispenser assembly and is constructed to accommodate near field communication with an active device bought proximate the material dispenser assembly to communicate an operating characteristic of the material dispenser assembly to the active device.

Another aspect of the invention discloses a method of interacting with a point of use dispenser assembly and includes positioning a portable active communication device proximate a non-portable dispenser assembly having a passive communication device associated with the non-portable dispenser assembly such that a near-field communication connection can be established between the portable active communication device and the passive communication device and information associated with a condition of the point of use dispenser assembly can be communicated between the passive communication device and the active communication device via the near-field communication connection.

These and other aspects, objects, features, and advantages of the present invention will become apparent from the detailed description, claims, and accompanying drawings.

### DESCRIPTION OF THE DRAWINGS

A clear conception of the advantages and features constituting the present invention, and of the construction and operation of typical mechanisms provided with the present invention, will become more readily apparent by referring to the exemplary, and therefore non-limiting, embodiments illustrated in the drawings accompanying and forming a part of this specification, wherein like reference numerals designate the same elements in the several views, and in which:

FIG. 1 is a perspective view of a roll material dispenser assembly having a volume monitoring system according to the present invention;

FIG. 2 is a perspective view of the roll dispenser assembly of FIG. 1 with the cover and roll of web material removed therefrom and exposing an interior of the base of the housing or enclosure of the dispenser assembly;

FIG. 3 is perspective view of a portion of the roll dispenser assembly of FIG. 2 with the cover removed therefrom and a material volume sensor exposed thereof;

FIG. 4 is a perspective view of another portion of the roll dispenser assembly of FIG. 2 with the cover removed therefrom and a controller that is in communication with the material volume sensor shown in FIG. 2 exposed thereat;

FIG. 5 is a view similar to FIG. 4 and shows a roll towel dispense assembly of the dispenser assembly shown in FIG. 1;

FIG. 6 is a schematic view associated with operation of the material volume sensor of the dispenser assembly shown in FIG. 1;

FIG. 7 is a perspective view of a liquid soap dispenser assembly having a volume monitoring system according to the present invention;

FIG. 8 is a perspective view of the liquid soap dispenser assembly of FIG. 7 with a cover oriented in an open position and a dispensable material reservoir being replenished; and

FIG. 9 is a front elevation view of a tissue material dispenser having a volume monitoring system according to the present invention.

### DETAILED DESCRIPTION OF THE PREFERRED EMBODIMENTS

In describing the preferred embodiments of the invention which are illustrated in the drawings, specific terminology will be resorted to for the sake of clarity. However, it is not intended that the invention be limited to the specific terms so selected and it is to be understood that each specific term includes all technical equivalents which operate in a similar manner to accomplish a similar purpose. The various features and advantageous details of the subject matter disclosed herein are explained more fully with reference to the non-limiting embodiments described in detail in the following description.

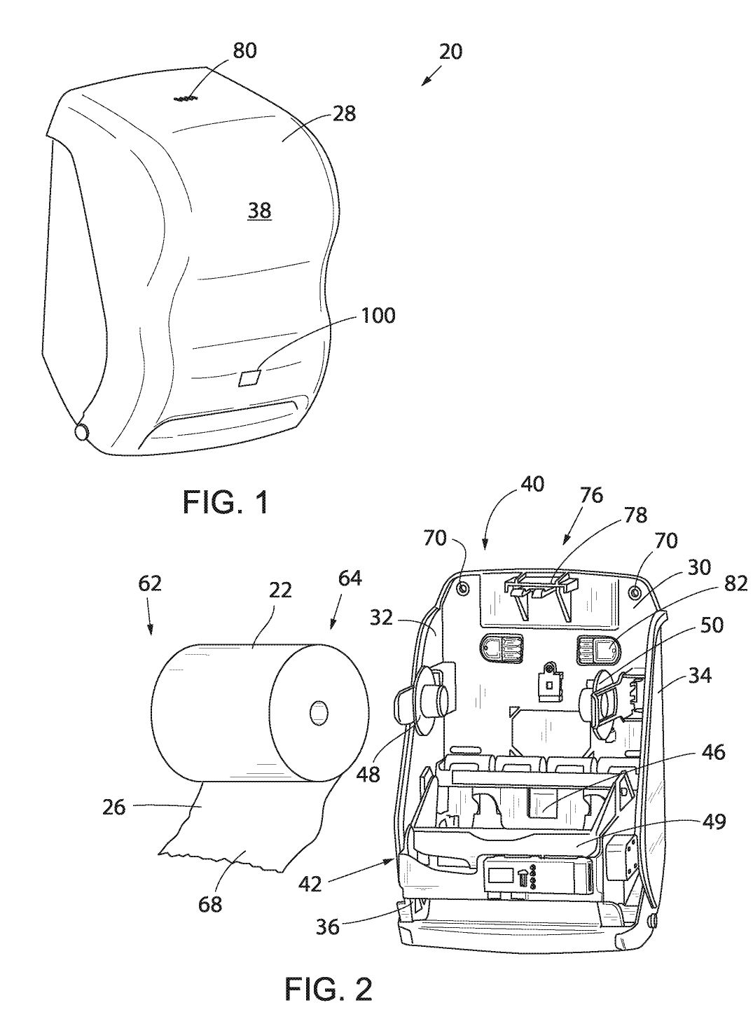

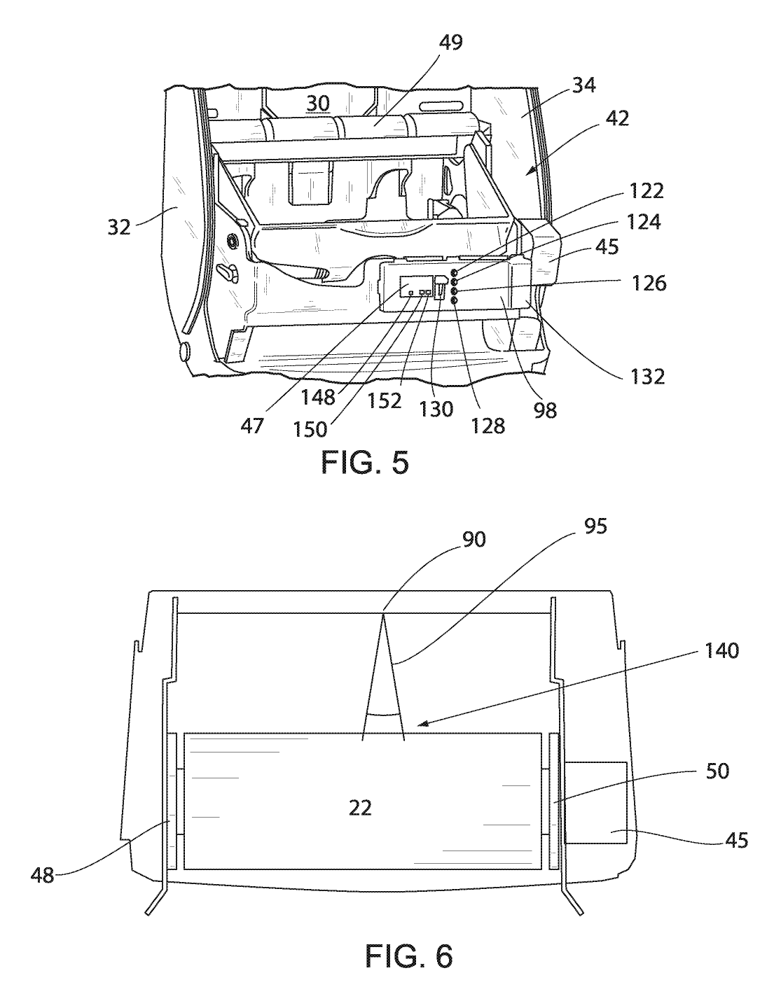

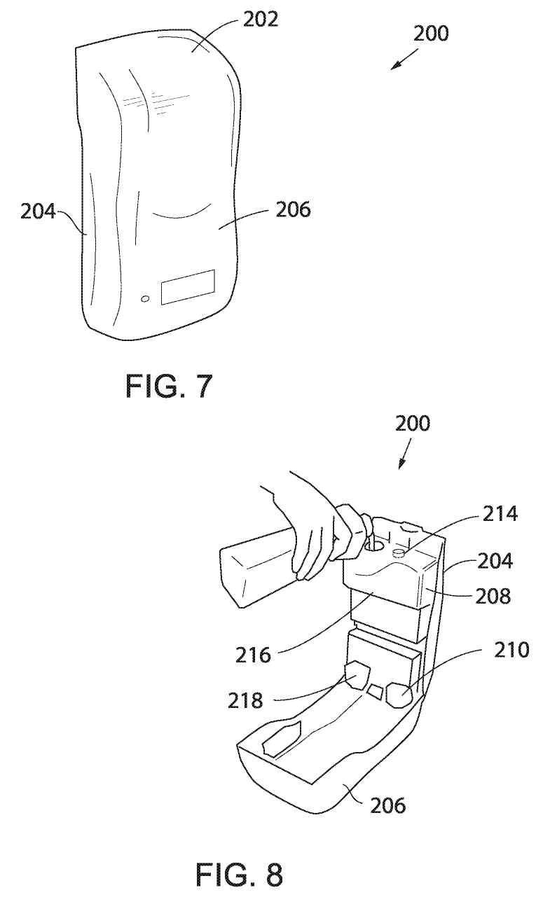

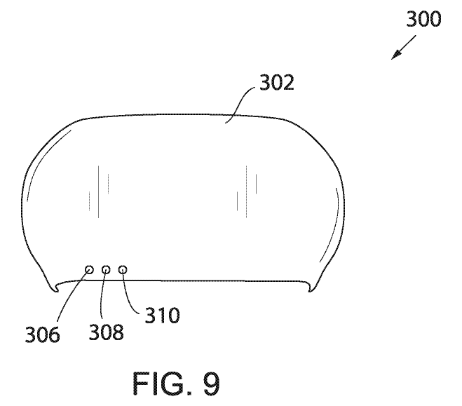

Illustrative embodiments of a various sanitation material dispenser assemblies 20, 200, and 300 in accordance with various aspects of the present invention are shown in FIGS. 1-9. As disclosed further below, FIGS. 1-6 show various views of a material dispenser assembly 20 that is constructed to incrementally dispense sanitation materials in the form of a hand towels, FIGS. 7 and 8 show respective views of a liquid hand soap dispenser assembly 200, and FIG. 9 shows a toilet tissue dispenser assembly 300 wherein each of dispenser assemblies 20, 200, and 300 are constructed to monitor an amount of sanitation material that is available for incremental dispensing directly to a user and in response to a user request from a respective dose of the discrete sanitation material that is incrementally dispensable from the discrete respective dispenser assembly 20, 200, 300.

Initially, referring to FIGS. 1 and 2, dispenser assembly 20 is constructed to incrementally dispense discrete doses of a hand towel or rolled web material from a bulk roll 22 of web material 26. Rolled web material dispenser assembly 20 includes a cabinet, housing, or enclosure 28 that is shaped to receive replaceable bulk roll 22 of sheet or web material 26. Enclosure 28 is defined by a base, back, or back wall 30, a first sidewall 32, a second opposing sidewall 34, a floor 36, and a front cover 38 that cooperate with one another to define an interior cavity 40 of enclosure 28. Enclosure 28 may be formed of plastic or other suitable material. The back wall 30, sidewalls 32, 34, and floor 36 collectively form a rear portion or base of enclosure 28. Preferably, back wall 30, sidewalls 32, 34, and floor 36 are provided in a unitary single body construction. Cover 38 movably cooperates with the rear or base portion of enclosure 28 to selectively expose cavity 40 associated with receiving discrete sequential rolls of web material 26 associated therewith. As disclosed above, it is appreciated that the rearward portion of enclosure 28 or that portion that is generally rearward of cover 38 may be formed as a single or multiple piece assembly formed by injection, blow, or roto molding. Alternatively, the various walls or panels that define enclosure 28 may be separately manufactured parts that are connected by methodologies such as welds, moldings, fasteners, solder, overlapping snap fit connections, or the like.

Referring to FIGS. 2-4, material dispenser 20 includes a dispense assembly, feed assembly, or feed mechanism 42 that is generally contained within enclosure 28. Although shown as an assembly that cooperates with enclosure 28, it is appreciated that in other embodiments, the feed mechanism 42 can be provided in the form of a cassette that can be assembled prior to being associated with enclosure 28. As disclosed further below, depending on the nature of the consumable material being dispensed, feed mechanism 42 may be provided in other form factors such as, for instance, a pump assembly of the like when aspects of the present invention are employed in soap dispensing endeavors. Regardless of the specific configuration when employed for paper material dispensing operations, feed mechanism 42 includes one or more rollers such as a drive roller 44 and an idle roller 46 that are positioned relative to one another to effectuate the dispensing of web material 26 beyond the confines of enclosure 28 and to a user. The drive roller 44 and the idle roller 46 form a pressure nip through which the web material is drawn prior to being dispensed beyond the confines or perimeter edge of enclosure 28. The drive roller 44 and the idle roller 46 extend transversely with respect to and are supported from the sidewalls 32, 34 of enclosure 28 such that the same are rendered rotatable about respective parallel axes. It will be appreciated that these axes are also generally parallel to the rotational axis of the roll 22 of sheet or web material 26 supported by respective retaining arms 48, 50 disposed in enclosure 28.

Still referring to FIGS. 2-4, the roll 22 of sheet or web material 26 is configured to be retained within the cavity 40 of the enclosure 28, above the feed mechanism 42. A first retaining arm 48 may extend outwardly from the back wall 30 adjacent the first side wall 32 and an opposing second roll retaining arm 50 may extend from the back wall 30 adjacent the second side wall 34. The first and second retaining arms 48, 50 may be received and retained within first and second receiving slots 56, 58 adjacent the first and second side walls 32, 34, respectively. A hub 60 extends inwardly from an outwardly extending end of the first and second arms 48, 50, and when used in combination are configured to rotatably receive the opposing longitudinal ends 62, 64 or sides of the roll 22 of sheet or web material 26.

In this configuration it will be appreciated that the bulk roll 22 of sheet or web material 26 is rotatably suspended above the feed mechanism 42, to spin about an axis that extends transversely with respect to the sidewalls 32, 34 of enclosure 28 and generally parallel to the rotational axis of the drive roller 44 and the idle roller 46. From this rotatably mounted position, an end 68 of the web material 26 extends downwardly for cooperation with the pressure nip and is advanced out of the enclosure 28 though a downwardly directed opening in the enclosure 28 upon activation, actuation, or rotation of the drive roller 44 by a drive motor, such as a stepped motor 45, whose operation effectuates rotation of drive roller 44. In one embodiment of the present invention, where the dispenser is a contactless system, the drive roller 44 is advanced by user interaction with a touchless operator such as a proximity sensor 47 or the like to effectuation operation of the feed mechanism. When provided in a powered dispensing configuration, dispenser assembly 20 may be constructed to be powered by grid power and/or a battery system 49 of the like.

In an alternative embodiment of the present invention, where the drive roller 44 is advanced or actuated by manual operation, such as a wheel or lever, the drive roller 44 may be mechanically associated with a manual drive mechanism whose operation is manually effectuated by mechanical actuation by the user to advance the material 26 from roll 22 through the rollers 44, 46 and therefrom toward the dispense opening defined by enclosure 28.

Still referring to FIGS. 1-3, a plurality of mounting holes or apertures 70 are located in the back wall 30 of the enclosure 28. The apertures 70 are configured to receive mounting hardware, such as a threaded fastener or peg, therein such that the material dispenser 20 may be affixed to a wall or other supporting structure. When the dispenser is mounted and the roll of webbed material 26 has been loaded into the cavity 28, with an end of the web material 26 extending downwardly within the pressure nip, the enclosure 28 is closed such that the cover 32 movably cooperates with the rear or base portion of enclosure 28 as shown in FIG. 1. Preferably, dispenser assembly 20 includes a lock mechanism 76 that is configured to provide only selective access to cavity 40 of enclosure 28 for service and/or reloading operations.

Lock mechanism preferably includes a resilient barb 78 that extends outwardly from the rear wall 30 of the base portion of the enclosure 28 near the top of the dispenser assembly 20. When closed, the resilient barb 78 deflects about and engages a corresponding fixed barb (not shown) disposed at the interior surface of a top portion of the cover 32. Such a configuration allows the overlapping barbs to maintain a friction fit closure between the cover 32 and base portion of the enclosure 28 when enclosure 28 is closed. A keyhole 80 is positioned in the top of the cover 32, at a location that overlies the resilient barb 78 when the dispenser assembly 20 is in the closed configuration. Inserting a corresponding elongated key 82 through the keyhole 80 allows the key 82 to downwardly deflect the resilient barb 78 and release the cover 32 from its engagement with the rear portion of the enclosure 28 to allow opening of dispenser assembly 20. It should be appreciated that, during deployment, one or more of keys 82 are removed from back portion 30 of enclosure 28 prior to deployment of dispenser assembly 20.

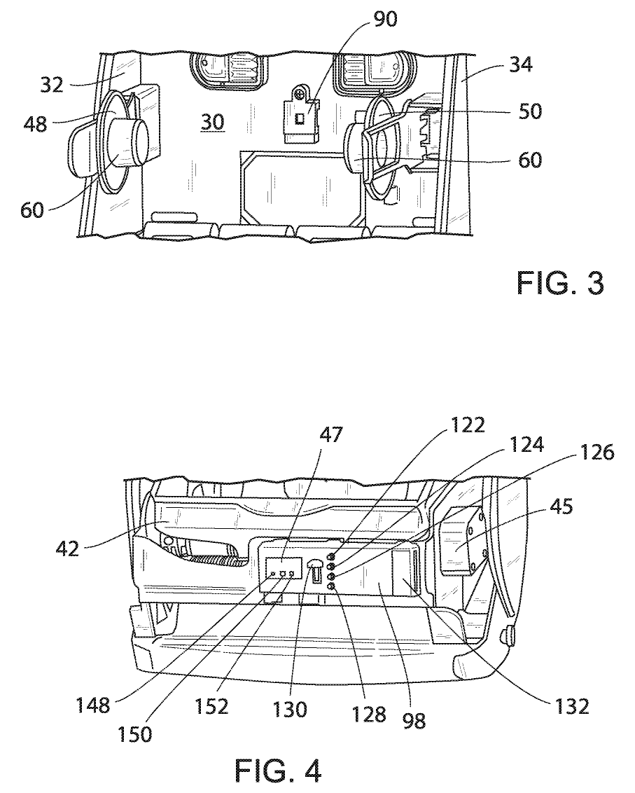

Turning now to FIGS. 3-6, and initially FIGS. 3 and 4, dispenser assembly 20 includes a sanitation material level sensor 90 that is supported by rear wall 30 of enclosure 28 and oriented to be in a line of sight communication 92 (FIG. 6) with roll 22 of material 26 disposed in enclosure 28 and is operates in a time of flight modality associated with communication of the signal 95 from sensor 90 and returned thereto after impingement of the signal 95 upon the available quantity of the sanitation material associated with roll 22. Sensor 90 is operationally connected to a control arrangement or controller 98 disposed behind cover 38 and proximate a window 100 having the dispense actuation sensor 47 associated therewith when dispenser assembly 20 is configured to automatically dispense a discrete dose of web material 26 in a touchless or powered dispense methodology.

Referring now to FIGS. 3-6, during use or deployment of dispenser assembly 20, roll 22 of sanitation material 26 is disposed in dispenser assembly and a tail thereof is associated with respective feed and pressure rollers as disclosed above. User interaction with proximity sensor 47 actuates discrete dispense events wherein a desired portion of web material 26 is dispensed beyond the confines of enclosure 28. In one embodiment of the present invention, controller 98 includes one or more inputs 122, 124, 126, 128, 130 that are configured to allow a user to interact with dispenser assembly 20 wherein a respective length of web material 26 associated with each discrete dispense event can be adjusted and the operation of level sensor 90 can be adjusted. As disclosed further below, in an alternate embodiment and/or in addition to the disclosure above, controller 98 can be operationally connected to a passive communication device 132 that is operable in a near-field-communication (NFC) modality. As disclosed further below, when provided with passive communication device 132, when a user or service personnel brings a portable communication device; such as a cell phone, tablet, a dedicated portable electronic service device, or other portable electronic device into close proximity to communication device 132; the positional proximity of the respective devices facilitate near-field-communication between the personal portable electronic device and the passive communication device 132 and controller 98 associated therewith. Regardless of the modality associated with user interaction with dispenser assembly 20, as disclosed further below, regardless of the relative adjustment associated with operation of level sensor 90, during operation of dispenser assembly 20, level sensor 90 is configured to assess a single level 140 of sanitation material that is available for dispensing. Although adjustable, single level 140 associated with level sensor 90 is between a full condition associated with bulk roll 22 and a depleted condition of bulk roll 22 during use of dispenser assembly 20. More preferably, single level 140 is associated with a level of bulk material 22 that is proximate a condition wherein service of dispenser assembly 20 is desired – such as via replenishment of a successive bulk roll 22.

Controller 98 can further include one or more indicators, such as light emitting diodes or the like 148, 150, 152, whose operation is indicative of, or provides an indication of single level 140 of sanitation material 26 remaining in dispenser assembly 20. In one embodiment, a single indicia or indicator can be provided and provides an indication inspectable from beyond the confines of enclosure 28, that the amount of material 26 available for dispensing is proximate the single level 140 as detected by sensor 90 and determined by controller 98 associated with the desired user preferences. When proximate single level 140, a respective indicator illuminates and thereby indicates the desire for service of dispenser assembly 20. In alternative configurations, additional indicators 148, 150 can be provided and configured such that indicator 148 indicates a condition or level of material 26 that is between a full condition and a condition proximate the single level 140 detected by sensor 90 and indicator 152 provides an indication that the level of material as between being proximate the single level 140 and a fully depleted condition.

As indicated in FIG. 6, single level 140 is detected by the impingement of signal 95 generated by sensor 90 upon the exterior surface of a remaining portion of bulk material roll 22 and the detection of the time of flight associated with communication of the resultant signal to sensor 90. Sensor 90 and controller 98 are configured to touchlessly assess a volume of bulk material that remains available for dispensing and does so in a cost effective manner that does not require physical interaction with either of the roll of bulk material and/or the drive mechanism associated with effectuating discrete dispense events. That is, rather than continual monitoring of an amount of material available for dispensing, dispenser assembly 20 is constructed to mitigate unnecessary power consumption, provides an economical and adjustable dispensable status indication, and mitigates mechanical interference between the dispense assembly and the level monitoring functionality of the dispenser assembly.

While the description above is generally directed to web material paper dispenser assemblies, it is appreciated that the single level detection and level indicator methodology disclosed therein is applicable to utilization with other sanitation material dispenser assemblies wherein discrete doses of respective sanitation materials are dispensed directly to the user of the discrete devices but deployment, maintenance, and service of the discrete dispenser assemblies are the responsibility of service and/or facility personnel. For instance, in addition to hand towel dispenser assemblies such as dispenser assembly 20, lavatory facilities commonly include other dispenser assemblies that are constructed to deliver discrete doses of sanitation materials from bulk sources to discrete users and which customarily require service and/or refilling as the discrete consumable sanitation materials are used. FIGS. 7 and 8 show an exemplary hand soap dispenser assembly 200 whereas FIG. 9 shows an exemplary toilet paper or tissue dispenser assembly 300. It is appreciated that each of dispenser assemblies 200, 300 could be constructed to be manually operable and/or touchlessly operable in manners similar to the disclosure above with respect to hand towel dispenser assembly 20.

As shown in FIGS. 7 and 8, liquid soap dispenser assembly 200 includes a housing 202 defined by a base portion 204 and a cover portion 206. A replaceable and/or refillable container or reservoir 208 is disposed within housing 202 and is in fluid communication with a dispense assembly or system, such as a pump assembly 210 or the like that delivers discrete doses of liquid soap to discrete users of dispenser assembly 200 when desired. Like dispenser assembly 20, dispenser assembly 200 includes a single level time of flight sensor 214 that is in line of sight communication with a top surface of liquid soap 216 disposed in reservoir 208. Sensor 214 is operatively connected to a controller 218 in the same manner as disclosed above with respect to dispenser assembly 20 so as to provide an indication as to a need for service dispenser assembly 200 when deployed and based on a single but adjustable detectable level of the liquid soap available for dispensing.

FIG. 9 shows a toilet tissue dispenser assembly 300 according to another embodiment of the present invention wherein the dispenser assembly 300 includes a housing 302 that is selectively openable to facilitate replenishment of the bulk materials disposed therein and includes a single level material detection system as disclosed above. Like dispenser assemblies 20, 200, dispenser assembly 300 includes one or more indicators 306, 308, 310 that can be selectively operated and provide an indication inspectable from outside housing 302 as to the presence of supply of bulk material as being proximate the single level, between a full condition and proximate the single level, and between the single level and a depleted condition. It is appreciated that discrete restroom or lavatory environments equipped with one or more of dispenser assemblies 20, 200, 300 can be readily inspected and serviced when necessary by personnel associated with such endeavors.

Further, it is appreciated that the level detection and dispense dose control arrangements disclosed herein may be implemented in a variety of configurations, using certain features or aspects of the embodiments described herein and others known in the art. Thus, although the invention has been shown and described in what is perceived to be the most practical and preferred embodiments, it is to be understood that the invention is not intended to be limited to the specific features and embodiments set forth above. Rather, it is recognized that modifications may be made by one of skill in the art of the invention without departing from the spirit or intent of the invention and, therefore, the invention is to be taken as including all reasonable equivalents to the subject matter of the claims.

It is further appreciated that, like dispenser assembly 20 as alluded to above, each of dispenser assemblies 200, 300 could similarly be constructed to accommodate near-field-communication between the discrete dispenser assembly and a respective portable electronic device such as a cell phone, tablet, dedicated electronic device or other methodology. When equipped with such functionality, each respective dispenser assembly 20, 200, 300 includes a passive near field communication device associated with the respective device and portable electronic device that is configured to communicate with the one or more of the discrete passive electronic devices such as device 132, when the portable electronic device is within a communication footprint relative to the distance between the passive communication device and the portable communication device. Whereas passive communication device 132 could be positioned relative to a respective cover of the discrete assembly 20, 200, 300 to facilitate communication therewith, in a preferred aspect of the present invention, the discrete dispenser assembly 20, 200, 300 is preferably in an open configuration to allow the desired communication therebetween. It should be appreciated that, when provided in a such a configuration, such an approach mitigates nefarious interaction with discrete dispenser assemblies 20, 200, 300 should an unauthorized third party acquire either of a device or other suitable graphical user interface (GUI) configured to allow communication between discrete dispenser assemblies 20, 200, 300 and the respective portable device.

The near field communication between passive communication device 132 and a respective portable communication device provides a short-range, touchless or wireless communication between the two respective near field communication enabled devices and facilitates the communication and exchange of data between discrete dispenser assemblies 20, 200, 300 equipped with passive communication device 132 when the respective passive and portable communication devices are brought within a few centimeters of each other. When the respective devices 132 and a portable suitably configured device are positioned proximate one another to facilitate the exchange of data across the near field communication connection, users or service personnel can interact with and manipulate the operation of the underlying dispenser assembly 20, 200, 300 without physical interaction with the resultant dispenser assembly 20, 200, 300 – aside from opening the respective cover thereof when so configured. Providing discrete dispenser assemblies 20, 200, 300 with passive communication device 132 further improves the energy efficiency associated with operation and deployment of dispenser assemblies 20, 200, 300 in as much as the discrete dispenser assemblies need not power discrete passive communication devices 132 during periods of no user interaction therewith. Such a configuration further enhances the security associated with interaction with such devices in as much as access to the discrete portable electronic devices and/or GUI’s intended to be operated therewith can be restricted to only those personnel associated with and/or responsible for service and/or maintenance of the underlying dispenser assemblies 20, 200, 300.

Further still, each discrete passive communication device 132 remains operable for interaction with and/or manipulation by a user or service personnel when a suitably configured and/or authorized portable communication device is brought into operable proximity relative to the discrete passive communication device 132 associated with a discrete dispenser assembly 20, 200, 300 regardless of the discrete dispenser assembly 20, 200, 300 having sufficient power - via battery, grid, or otherwise - to effectuate operation thereof. The passive communication device 132 associated with each dispenser assembly 20, 200, 300 remains operable for interaction with suitably configured portable electronic devices without presenting a consumptive or parasitic electrical load to the power system associated with effectuating the dispense operations and thereby improves the duration between service events associated with battery operated dispenser assemblies. Such a consider further allows user and/or service personnel interaction with each discrete dispenser assembly 20, 200, 300 even though the batteries associated therewith may be depleted and/or grid power has been interrupted.

When wirelessly connected to a respective passive communication device 132 associated with a respective dispenser assembly 20, 200, 300; user interaction with a portable electronic device can allow assessment and/or manipulation of the operating conditions associated with the underlying discrete dispenser assembly 20, 200, 300. For instance, it is envisioned that user’s and/or service personnel would be able to access discrete dispenser assembly information such as a date of manufacture of the discrete dispenser assembly, a date the discrete dispenser assembly entered into service, a total amount of material - whether towel, tissue, or soap - that has been dispensed, a dispenser assembly remaining battery level, a level of material left to be dispensed – whether soap, towel, or tissue, jam and/or dispense error historical data, characteristics or suppliers associated with materials to be dispensed, etc. In a preferred aspect, data related to the historical operation of any discrete dispenser assembly 20, 200, 300 can be assessed and monitored via user interaction with the portable communication device but is incapable of being adjusted and/or otherwise deleted or manipulated by the service personnel as such information is related to the historical operation of the discrete dispenser assemblies 20, 200, 300.

In a further aspect to the present invention, user’s and/or service personnel can preferably adjust and/or manipulate other parameters, information, and/or data associated with discrete dispenser assemblies via the communication of such instructions between the portable communication device and passive communication device 132 and the near field communication therebetween. For instance, it is envisioned that user or service personnel interaction with the portable communication device when positioned in communicative proximity to a respective passive communication device 132 associated with a respective dispenser assembly 20, 200, 300 may communicate instructions to the discrete dispenser assemblies 20, 200, 300 to adjust or manipulate an amount of dispensed material to be dispensed with each dispense event – such as paper length of volume of soap as the discrete dispenser assembly may dictate; a delay duration between discrete dispense events, a discrete mode of operation – as manual, automatic or dispense sense mode, a battery saver mode, etc., a dispense speed – such as changing the speed of operation of motors or pumps or the like, a sense range – such as setting the discrete distance associated with operation of material level sensor 90 and/or the signal 95 associated with operation thereof, effectuate a reset to achieve a previous setting conditions whether factory or otherwise, etc. It is appreciated that while various information and/or data exchanged across the near field communication communication channel between passive communication device 132 and a respective portable communication device positioned proximate thereto has been designated as adjustable, non-adjustable, settable, or read-only; it is appreciated that discrete users may have discrete preferences and/or segregation between discrete users or service personnel as to information that is accessible or inaccessible to discrete classes of users and/or information and/or operating parameters that are adjustable or non-adjustable to discrete users or service personnel that are unique to the preferences of discrete users. It is envisioned that the discrete portable communication devices can be individually configured per discrete user devices so as to allow only access and/or adjustment of discrete operating parameters of discrete dispenser assemblies 20, 200, 300 as the preferences of a discrete environment may dictate.

Therefore, one embodiment of the present invention is a sanitation material dispenser assembly that includes a housing defined by a cover that movably cooperates with a base. A cavity is defined by the housing and is shaped to support a supply of a consumable material. A dispense assembly is disposed in the housing and is configured to incrementally dispense the consumable material to an end user of the consumable material such that the consumable material can be incrementally depleted from a full condition to a depleted condition. A controller is supported by the housing and a sensor is connected to the controller. The sensor is configured to detect a single level of the consumable material wherein the single level is between the full condition and the depleted condition of the consumable material. The dispenser assembly includes an output that provides an indication external to the housing of an available level of the consumable material relative to the single level.

Another embodiment of the invention that is combinable or useable with one or more of the above embodiments is a material dispenser assembly that includes a housing that is constructed to support a bulk supply of a material to be dispensed. A dispense assembly is disposed in the housing and configured to incrementally dispense the material from the bulk supply between a full condition and a depleted condition during use of the material dispenser assembly. A controller is disposed in the housing and a sensor is operatively connected to the controller and configured to touchlessly detect a single level that is between the full condition and the depleted condition of the material available in the housing.

A further embodiment of the present invention that is useable and/or combinable with one or more of the above embodiments includes a method of forming a dispenser assembly. The method includes providing a housing that is shaped to generally enclose a volume of a dispensable material. A dispense assembly is provided that incrementally dispenses the dispensable material from the housing to a user of the dispensable material in response to a request from a user for a discrete dose of the dispensable material. A sensor is provided that detects a single level that is between a full level condition and a depleted level condition associated with the capacity of the housing of the dispensable material, that is available for dispensing. The sensor is connected to an indicator that is inspectable from outside the housing and whose operation is indicative of a volume of the dispensable material that is available for dispensing being proximate the single level. In a preferred aspect, the dispenser assembly is constructed to provide multiple indicators associated with discrete levels of dispensable material being available and determined from the sensed single level.

Another embodiment of the invention useable with one or more of the features, aspects, or embodiments disclosed above includes a sanitation material dispenser assembly having a housing that is constructed to enclose a bulk volume of a dispensable material. A dispense system is constructed to incrementally dispense directly to a user a discrete dose of the bulk material directly to the user in response to a dispense instruction. A control arrangement is configured to receive the dispense instruction and actuate the dispense system upon receipt of the dispense instruction to effectuate a dispense event. The control arrangement is further configured to wirelessly communicate with a personal device positioned within line-of-sight proximity to the dispenser assembly and allows wireless communication between the personal device and the control arrangement of the dispenser assembly. Preferably, the wireless communication between the personal device and the control arrangement is effectuated via a near field communication methodology therebetween.

Another embodiment of the invention that is useable or combinable with one or more of the features, aspects, or embodiments disclosed above includes a material dispenser assembly having a housing that is constructed to support a bulk supply of a material to be dispensed and a dispense assembly incrementally dispenses the material from the bulk supply between a full condition and a depleted condition during use of the material dispenser assembly. A passive communication device is associated with the material dispenser assembly and is constructed to accommodate near field communication with an active device bought proximate the material dispenser assembly to communicate an operating characteristic of the material dispenser assembly to the active device.

A further embodiment of the invention that is useable or combinable with one or more of the above embodiments includes a method of interacting with a point of use dispenser assembly and includes positioning a portable active communication device proximate a non-portable dispenser assembly having a passive communication device associated with the non-portable dispenser assembly such that a near-field communication connection can be established between the portable active communication device and the passive communication device and information associated with a condition of the point of use dispenser assembly can be communicated between the passive communication device and the active communication device via the near-field communication connection.

These are other aspects, advantages, features, and equivalents thereof, are encompassed by the appending claims.

What is claimed is:

1. A sanitation material dispenser assembly comprising:
a housing defined by a cover that movably cooperates with a base;
a cavity defined by the housing and that is shaped to support a supply of a consumable material;
a dispense assembly disposed in the housing and configured to incrementally dispense the consumable material to an end user of the consumable material and wherein the consumable material can be incrementally depleted from a full condition to a depleted condition;
a controller supported by the housing;
a sensor connected to the controller and configured to detect a single level of the consumable material wherein the single level is between the full condition and the depleted condition of the consumable material; and
an output that provides an indication external to the housing of an available level of the consumable material relative to the single level.

2. The sanitation material dispenser assembly of claim 1 wherein the indication provided by the output is further defined as a plurality of indications.

3. The sanitation material dispenser assembly of claim 2 wherein a first of the plurality of indications indicates a level of the consumable material that is between the full condition and the level proximate the single level, a second of the plurality of indications indicates another level of the consumable material that is between another level proximate the single level and the depleted condition, and a third of the plurality of indications indicates another level of the consumable material that is between the first of the plurality of indications and the second of the plurality of indications.

4. The sanitation material dispenser assembly of claim 1 wherein the dispense assembly is further defined as one of a tissue material dispense assembly or web material dispense assembly.

5. The sanitation material dispenser assembly of claim 4 wherein the single level detected by the sensor is internal to a full roll of rolled material.

6. The sanitation material dispenser assembly of claim 5 wherein the controller is configured to adjust a value of the single level detected by the sensor.

7. The sanitation material dispenser assembly of claim 1 wherein the dispense assembly is further defined as a liquid soap dispense assembly.

8. The sanitation material dispenser assembly of claim 7 wherein the sensor is arranged with a line of sight to an upper surface of a level of liquid soap contained in the liquid soap dispenser assembly.

9. The sanitation material dispenser assembly of claim 7 wherein the dispenser assembly further comprises a container for containing a volume of liquid soap.

10. The sanitation material dispenser assembly of claim 9 wherein the sensor is exposed to a volume defined by the container.

11. A material dispenser assembly comprising:
a housing constructed to support a bulk supply of a material to be dispensed;
a dispense assembly that incrementally dispenses the material from the bulk supply between a full condition and a depleted condition during use of the material dispenser assembly;
a controller disposed in the housing; and
a sensor operatively connected to the controller and configured to touchlessly detect a single level of the material available in the housing and wherein the single level is between the full condition and the depleted condition.

12. The material dispenser assembly of claim 11 further comprising at least one indicator connected to the controller and that is inspectable from outside of the housing to provide an indication of the material available in the housing being proximate a value associated with single level.

13. The material dispenser assembly of claim 12 wherein the at least one indicator further comprising another indicator whose operation is indicative of the level of material available in the housing being between the full condition and the value proximate the single level and another indicator whose operation is indicative of the level of material available in the housing being between the value proximate the single level and the depleted condition.

14. The material dispenser assembly of claim 11 wherein the dispenser assembly is further constructed to dispense one of a rolled tissue material, a rolled web material, and a liquid soap material.

15. The material dispenser assembly of claim 14 wherein the dispense assembly is constructed to incrementally dispense a liquid soap material and the sensor is configured to emit a signal onto a surface of the material to be dispensed.

16. The material dispenser assembly of claim 11 wherein the sensor is further defined as a time-of-flight dispenser.

17. The material dispenser assembly of claim 11 further comprising at least one of another sensor disposed in the housing and that is configured to initiate each dispense event and a mechanical actuation mechanism that is constructed to initiate each dispense event.

18. A method of forming a dispenser assembly, the method comprising:
providing a housing that is shaped to generally enclose a volume of a dispensable material;
providing a dispense assembly that incrementally dispenses the dispensable material from the housing to a user of the dispensable material in response to a request from a user for a discrete dose of the dispensable material;
providing a sensor that detects a single level of the dispensable material that is available for dispensing, wherein the single level of the dispensable material is between a full level condition and a depleted level condition associated the capacity of the housing; and
connecting the sensor to an indicator that is inspectable from outside the housing and whose operation is indicative of a volume of the dispensable material that is available for dispensing being proximate the single level.

19. The method of claim 18 further comprising connecting a controller between the sensor and the indicator.

20. The method of claim 18 wherein the single level is adjustable.

21. The method of claim 18 further comprising providing another indicator that is inspectable from outside the housing and whose operation is indicative of the volume of dispensable material that is available for dispensing being greater than proximate the single level.

22. The method of claim 18 further comprising providing another indicator that is inspectable from outside the housing and whose operation is indicative of the volume of dispensable material that is available for dispensing being less than proximate the single level.

23. The method of claim 18 wherein the volume of dispensable material is further defined as one of a rolled tissue material, a rolled web towel material, and a liquid soap material.

24. The method of claim 18 wherein the sensor is further defined as a time of flight sensor.

25. A sanitation material dispenser assembly comprising:
a housing constructed to enclose a bulk volume of a dispensable material:
a dispense system constructed to incrementally dispense directly to a user a discrete dose of the bulk material directly to the user in response to a dispense instruction;
a control arrangement configured to receive the dispense instruction and actuate the dispense system upon receipt of the dispense instruction to effectuate a dispense event; and
wherein the control arrangement is configured to wirelessly communicate with a personal device positioned within line-of-sight proximity to the dispenser assembly and allows wireless communication between the personal device and the control arrangement of the dispenser assembly.

26. The sanitation material dispenser assembly of claim 25 wherein a parameter associated with each dispense event and wherein connectivity between the control arrangement and the personal device is limited to instances wherein the housing of the dispenser assembly is in an open condition.

27. The sanitation material dispenser assembly of claim 25 wherein wireless communication between the control arrangement and the personal device is further defined as a near-field communication.

28. The sanitation material dispenser assembly of claim 27 wherein at least one of a date of manufacture, a service entry date, a total amount of material dispensed, a battery level, a consumable material level, and a number of dispense errors is communicated on the near-field communication between the control arrangement and the personal device.

29. The sanitation material dispenser assembly of claim 28 wherein the at least one of a date of manufacture, a service entry date, a total amount of material dispensed, a battery level, a consumable material level, and a number of dispense errors is communicated on the near-field communication between the control arrangement and the personal device is non-adjustable.

30. The sanitation material dispenser assembly of claim 27 wherein at least one of a per dispense event dispense amount, a delay between discrete dispense events, a mode of operation, a power saver mode, a factory reset, and a sensor range of operation is communicated on the near-field communication between the control arrangement and the person device.

31. The sanitation material dispenser assembly of claim 30 wherein the at least one at least one of a per dispense event dispense amount, a delay between discrete dispense events, a mode of operation, a power saver mode, a factory reset, and a sensor range of operation can be adjusted by a personal device when a personal device is in communication with the control arrangement via the near-field communication.

32. The sanitation material dispenser assembly of claim 25 wherein connectivity between the control arrangement and the personal device is limited to communication with one dispenser assembly at a given time.

33. The sanitation material dispenser assembly of claim 25 wherein the dispensable material is further defined as one of a tissue material, a towel material, and a liquid soap material.

34. The sanitation material dispenser assembly of claim 25 further comprising a sensor connected to the control arrangement and configured to detect a single level of the consumable material wherein the single level is between the full condition and the depleted condition of the consumable material.

35. The sanitation material dispenser assembly of claim 34 wherein the sensor is further defined as a near field communication sensor.

36. A material dispenser assembly comprising:
a housing constructed to support a bulk supply of a material to be dispensed;
a dispense assembly that incrementally dispenses the material from the bulk supply between a full condition and a depleted condition during use of the material dispenser assembly; and
a passive communication device associated with the material dispenser assembly and constructed to accommodate near field communication with an active device bought proximate the material dispenser assembly to communicate an operating characteristic of the material dispenser assembly to the active device.

37. The material dispenser assembly of claim 36 wherein the operating characteristic is at least one of a material dispense amount, a delay between dispense events; an operating mode of the dispense assembly, a battery condition, an operating speed associated with the dispense assembly, a range of operation of the passive communication device, a manufacture date, a date of service entry, a total amount of material dispensed, a battery level, a material available for dispense lever, and dispense errors.

38. The material dispenser assembly of claim 37 wherein the operating characteristic is adjustable via user interaction with the active device.

39. The material dispenser assembly of claim 36 further comprising a control arrangement that is operationally connected to the passive device.

40. The material dispenser assembly of claim 36 wherein the housing is further defined as a base and a cover that pivotably cooperates with the base and wherein connectivity between the active device and the passive device is allowed only when the cover is in an open position relative to the base.

41. The material dispenser assembly of claim 36 wherein the bulk supply of the material is further defined as one of a volume of liquid soap, a roll of tissue, and a roll of towel.

42. The material dispenser assembly of claim 36 further comprising a time-of-flight sensor constructed to indicate a level of the bulk material between a full condition and an empty condition.

43. A method of interacting with a point of use dispenser assembly, the method comprising:
positioning a portable active communication device proximate a non-portable dispenser assembly having a passive communication device associated with the non-portable dispenser assembly such that a near-field communication connection can be established between the portable active communication device and the passive communication device and information associated with a condition of the point of use dispenser assembly can be communicated between the passive communication device and the active communication device via the near-field communication connection.

44. The method of claim 43 further comprising opening a cover of the point of use dispenser assembly to effectuate connectivity between the portable active communication device and the passive communication device.

45. The method of claim 43 further comprising communicating at least one operating characteristic associated with operation of the non-portable dispenser assembly between the passive communication device and the portable active communication device via the near-field communication connection when the portable active communication device is positioned proximate the passive communication device.

46. The method of claim 45 wherein the at least one operating characteristic is further defined as at least one of a material dispense amount, a delay between dispense events; an operating mode of the dispense assembly, a battery condition, an operating speed associated with the dispense assembly, a range of operation of the passive communication device, a manufacture date, a date of service entry, a total amount of material dispensed, a battery level, a material available for dispense lever, and dispense errors.

47. The method of claim 45 further comprising at least one of allowing adjustment of and only allowing assessment of the at least one operating characteristic.

48. The method of claim 43 further comprising providing a time-of-flight sensor associated with the non-portable dispenser assembly wherein the time-of-flight sensor is constructed to assess a quantity of dispensable material available for dispensing.

49. The method of claim 48 wherein the time-of-flight sensor is further constructed to actuate an alert when the quantity of dispensable material reaches a discrete volume.
